(19) United States
(12) Patent Application Publication
(10) Pub. No.: US 2018/0036849 A1
(43) Pub. Date: Feb. 8, 2018

(54) CUTTING GUIDE

(71) Applicant: Stephen B. Smith, Wilmington, NC (US)

(72) Inventor: Stephen B. Smith, Wilmington, NC (US)

(21) Appl. No.: 15/555,107

(22) PCT Filed: Apr. 23, 2015
(86) PCT No.: PCT/US2015/027192

§ 371 Date: Sep. 1, 2017

(51) Int. Cl. B23Q 9/00; B23D 59/00; B27B 9/04

(52) U.S. Cl. CPC B23Q 9/0042; B27B 9/04; B23D 59/00; B27C 5/10

(57) ABSTRACT

This invention provides a guide for use with cutting power tools such as routers, circular saws, rotary cutters and the like. The invention provides a secure path along which a power tool can be used. The invention provides a device that is securely held against a surface by either user pressure or suction pressure and maintains its position along the surface to be cut. The invention can be configured to provide for varying cutting tools and differing attachments that are on the cutting tool and would be slid along the invention to effectuate a cut.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

Power cutting hand tools, including circular saws, grinders, routers, and other power saws are useful for rapid cutting of materials or grinding of substrates against which the blade, router bit, or grinding member may be applied. Careful control of such power tools is essential to complete an accurate cut and avoid unintended damage to both material or substrate being cut and the adjacent structures. A particular problem in the current state of the art is that as a result of the substantial cutting power of modern power tools, in the event of even a momentary misalignment of the blade in relation to an intended cut line may result in significant damage to the material or adjacent structures.

Furthermore, it may be necessary for a user to avoid the use of various power cutting tools deemed to be especially prone to accidental misalignment when cutting or grinding certain substrates including grout disposed between tiles or stones on floors and walls. The use of more easily controlled alternative power tools may increase inefficiency and result in greater time required for work completion and consequent higher cost.

To help combat this problem, many power tools such as circular saws, jig saws, and routers are manufactured with an integral flat base plate attached to the primary housing of the tool's motor. During use of the power tool, this base plate supports the weight of the tool and rests upon the substrate being cut. The power tool's blade or cutting member extends past the base plate in a generally perpendicular plane relative to the base plate. In typical circular saw and jig saw design the base plate is generally rectangular and the cutting blade is parallel with two sides of the base plate. In other power tools, such as routers, the base plate is typically round in shape and the cutting bit protrudes through a hole in the center. In yet another variety of power tools, such as spiral saws and rotary tools, a collar may be removably attached over the working end of the tool that houses the cutting bit. The collar is analogous to the base plate of a router and features a flat surface that rests upon the substrate to be cut while the cutting bit extends beyond the flat surface of the collar to make a cut as the flat surface of the collar moves across a work piece. The base plate is commonly adjustable relative to the saw blade or cutting bit to allow a user to select a desired depth of cut or angle of cut relative to the base plate.

While the use of a base plate affixed to the power tool does aid in maintaining some degree of control over the tool, there is a fundamental limitation with this solution. Specifically, the base plate is attached to the power tool, and it therefore moves whenever the power tool is moved. As such, it is susceptible to unintended movements from the user. A partial solution to this problem that the industry has developed is the use of a detached guide rail.

A detached guide rail is an apparatus that is well-known in the art. A guide rail provides a means for continuously maintaining proper alignment of a power saw blade or router bit upon a material or substrate to be cut. Since the detached guide rail is not affixed to the power tool, it is not susceptible to unintentional movements by the user. Thus, the guide rail can be securely fastened to the material or substrate to be cut to provide a secure, nonmoving guide along which the power tool can move. Improved control of the tool allows completion of cuts with greater speed and efficiency. The use of a guide rail can allow a user to utilize a particular type of power cutting tool that cannot be reliably controlled without a guide rail. Guide rails are typically affixed to materials to be cut using clamps or other conventional mounting means. Once the guide rail is secured to the material, it allows a user to accurately complete a linear cut by maintaining the outer margin of the tool's base plate firmly in position by aligning it against the guide rail while pushing the power tool forward along the length of the guide rail down the material to be cut. The secured guide rail and the cut line are therefore parallel separated by the distance between the outer edge of the power tool base plate and the edge of the cutting blade or bit.

In the case of power router design, the base plate is round and the router bit is positioned at the center of the circular base plate. Therefore there is a consistent distance between the cutting bit and any point along the perimeter of the base plate. By keeping the router base plate against a guide rail, the router bit cuts in a straight line or a curved line in accordance with the shape of the guide rail.

The current state of the art with respect to cutting guides can best be appreciated by an analysis of various devices currently known. U.S. Pat. No. 4,867,425 issued to Miraglia (1989) utilizes an elongated, flat, metal plate with an upwardly oriented flange along one of the long margins that acts as a guide rail for a power saw. The metal plate is bolted to a flat piece of lumber or plastic such that the distance from the guide rail to the lateral edge of the lumber corresponds to the distance from the saw's base plate to the edge of the blade of the power tool. The metal plate with the lumber or plastic attachment is positioned where desired and affixed by clamps to the substrate material to be cut. Thus, this device requires the use of additional tools, clamps, to secure it to the material to be cut.

U.S. Pat. No. 7,063,000 issued to Molburg (2006) describes a similar portable metal guide bar apparatus that additionally provides integral clamping assemblies to affix the apparatus to the material or substrate to be cut. This and similar designs have disadvantages that include the additional time required for the user to apply clamps or clamp assemblies to secure the apparatus to the substrate to be cut. Additionally, guide rail stabilization to the material or substrate with clamps or clamp assemblies requires access to both a top and a bottom surface of the substrate. Thus, the substrate to be cut cannot lie flat upon the floor, nor can the substrate to be cut be part of the floor itself, such as grout.

U.S. Pat. No. 4,539,881 issued to Maier (1985) discloses a power tool guide apparatus that is not provided with clamps for stabilization upon the substrate work surface. In this design there is a vertical guide rail perpendicularly attached to a flat plate that rests upon the substrate to be cut. The lower surface of the flat plate portion of this apparatus is described to have “slip proof” facing material. This facing material is proposed to increase the coefficient of friction between the plate and the substrate to be cut by virtue of the forces acting upon it by the use of the saw. A subsequent patent issued to Maier, U.S. Pat. No. 4,619,170 (1986) further modifies the earlier patent design to include means to physically engage the saw base plate and the guide plate, and additionally, means by which the flat plate portion of the apparatus may be clamped onto the substrate to be cut.

The aforementioned designs suffer from one or more shortcomings. Those designs that require stabilization of the cutting guide apparatus to the substrate to be cut using clamps require extra time for the user to apply clamps or clamp assemblies. In addition, clamps cannot be utilized to position a guide rail apparatus to a floor or a wall when a user wishes to cut tiles or grind grout disposed in spaces between tiles or stones in a floor or a wall. Early designs rely upon slip proof material to reliably stabilize the guide plate by increased friction between the guide plate and the substrate surface. When this frictional force is augmented by only the forces resulting from operation of the power tool, this frictional force alone may not reliably prevent slippage and unintended displacement of the guide apparatus relative to the substrate during cutting operations. Errant cuts associated with incomplete stabilization of any power tool guide apparatus may result in costly damage to the substrate being cut. Finally, the surface of floor tile or wall tile is commonly quite smooth and conventional designs may provide inadequate resistance to slippage of the cutting guide when a user wishes to cut grout disposed between floor or wall tiles.

A key element that distinguishes various designs in the prior art is the means of stabilization or fixation of the guide rail apparatus relative to the substrate that is to be cut. Many prior art designs feature a guide rail apparatus that requires the use of clamps to affix the guide rail apparatus to the substrate. This is problematic because the use of a clamp requires that there be two sides, usually an upper and an underside so that the clamp can squeeze. The problem arises when there is no access to the underside, such as in the case of cutting grout on a floor. A clamp cannot be used, because the underside of the floor is not accessible. Those prior art designs that rely upon frictional force between the guide rail and the power tool to maintain stability between the guide rail and the substrate to be cut offer no means by which such frictional forces may be sufficiently augmented to reliably prevent movement of the guide rail and potential damage to the substrate to be cut.

### BRIEF SUMMARY OF THE INVENTION

During operation of a power tool it is essential that a guide rail is continuously maintained in a reliably stationary position relative to the substrate being cut in order to complete an accurate cut and avoid inadvertent damage to the substrate or adjacent structures. One object of the present invention is to overcome shortcomings of previously proposed designs of portable guide rails and guide rail assemblies. An additional object of the present invention is provide a simple and inexpensive means of temporary fixation of a guide rail to a substrate without the need for clamps or clamp assemblies that are tightened to grip both a top and a bottom surface of the substrate to be cut. In particular, a further object of the present invention is to provide a guide rail design that may be rapidly positioned upon the surface of a substrate such as a tile floor or wall with temporary fixation that is sufficiently reliable to allow the safe use of a circular power saw to cut grout with minimal risk of damage to adjacent tiles.

It is an object of the invention to provide a cutting guide that guides a power cutting tool in a straight line. It is further an object of the invention to provide a cutting guide having a control plate and a connecting plate affixed to the control plate and extending in a generally perpendicular relation from the control plate. In addition, there is a guide plate affixed to the connecting plate and extending in a generally perpendicular direction from the connecting plate such that the guide plate is generally parallel to the control plate. It is contemplated that the control plate, connecting plate, and guide plate are aligned to form a plane.

It is yet a further object of the present invention to provide a rail affixed to the guide plate that extends upwardly from the plane formed by the control plate, connecting plate, and guide plate. The rail is securely held vertically from the plane by the guide plate.

It is a still further object of the present invention to provide a cutting guide having a pressure pad affixed to the top surface of the control plate and a foot affixed to the underside of the control plate. The foot can also be present on the underside of the connecting plate and guide plate, and the foot provides additional friction between the cutting guide and the surface upon which it is placed. It is also contemplated that there will be a handle affixed to the top surface of the control plate to aid in handling the cutting guide.

It is further an object of the present invention to provide one or more alignment rods affixed to the guide plate such that the alignment rods can be placed on or into the material to be cut. It is also contemplated that the control plate, guide plate, and rail can be adjustable in length.

It is further an object of the present invention to provide a cutting guide having a control plate and a lockable hinge affixed to one end of the control plate. The hinge is also connected to a guide plate wherein the lockable hinge is adjustable and can be locked into a plurality of positions. The invention also has a rail affixed to the guide plate and extending upwardly from the guide plate, such that the rail is securely held vertically. It is further contemplated that the invention can have a pressure pad affixed to the top surface of the control plate and where a foot is affixed to the underside of the control plate, connecting plate, and/or guide plate. Also, it is contemplated that the invention has a handle affixed to the top surface of the control plate.

It is still further an object of the present invention to provide a cutting guide having a control plate and a support affixed to and extending vertically along the length of the control plate. There are a plurality of hinges disposed along the top surface of the support and attached to a second support such that the second support can rotate about an axis defined by the plurality of hinges. Thus, the support and second support that are connected by the hinges can form adjustable angles. It is further an object of the present invention to provide a rail affixed to the second support and extending the length of the second support such that the rail rotates with the second support and can rotate to an angle such that the rail contacts the control plate in approximately a 90 degree angle and provides a surface against which a power cutting tool can be placed. Attached to the support is a beam that extends away from the support. Attached to the other end of the beam is a suction cup apparatus oriented downwardly in order to engage a surface upon which the cutting guide is placed and create suction. This functions to secure the control plate to the surface. It is further contemplated that there is a pressure pad affixed to the top surface of the control plate and a foot affixed to the underside of the control plate. The foot provides additional friction between the cutting guide and the surface upon which it is placed. It is also contemplated that the invention has a handle affixed to the top surface of the control plate.

### BRIEF DESCRIPTION OF THE SEVERAL VIEWS OF THE DRAWING(S)

FIG. 1 is a perspective view of the cutting guide.

FIG. 2 is a side view of the cutting guide.

FIG. 3 is a perspective view of a first alternative embodiment of the cutting guide.

FIG. 4 is a side view of the first alternative embodiment of the cutting guide.

FIG. 5 is a side view of a second alternative embodiment of the cutting guide.

FIG. 6 is a top view of the second alternative embodiment of the cutting guide.

FIG. 7 is a side view of the second alternative embodiment of the cutting guide.

### DETAILED DESCRIPTION OF THE INVENTION

The following detailed description is of the best currently contemplated modes for carrying out the preferred embodiments of the present invention. The detailed description of the embodiments of the present invention should not be read to in any way limit the scope of the present invention. Rather, the detailed description is simply to illustrate the guiding principles of the present invention. The scope of the present invention is defined by the appended claims.

In a preferred embodiment, the present invention provides two primary components. The first component is a guide plate with a generally perpendicularly affixed guide rail that extends along the length of the guide plate. The second component is a control plate that is rigidly connected to the guide plate such that temporary fixation of the control plate upon a work surface results in consequent fixation of the guide plate. The saw guide may be manufactured with a direct connection between the primary components or such connection may be provided by a connecting plate. The guide plate provides a flat surface along which the base plate of a cutting tool is moved while also maintaining contact with the guide rail, to thereby allow a user to cut in a straight line. When performing cuts on a horizontal surface substrate a user exerts downward force on the pressure plate of the saw guide to prevent slippage of the saw guide upon the substrate while performing a cut. This force may be provided by resting a knee on the pressure plate, by pressing downward upon a handle on the pressure plate, or both. This force may be provided by alternate means as chosen by the user. Once a cut is made, the cutting guide can be easily moved into the next position to facilitate further cutting along a straight line.

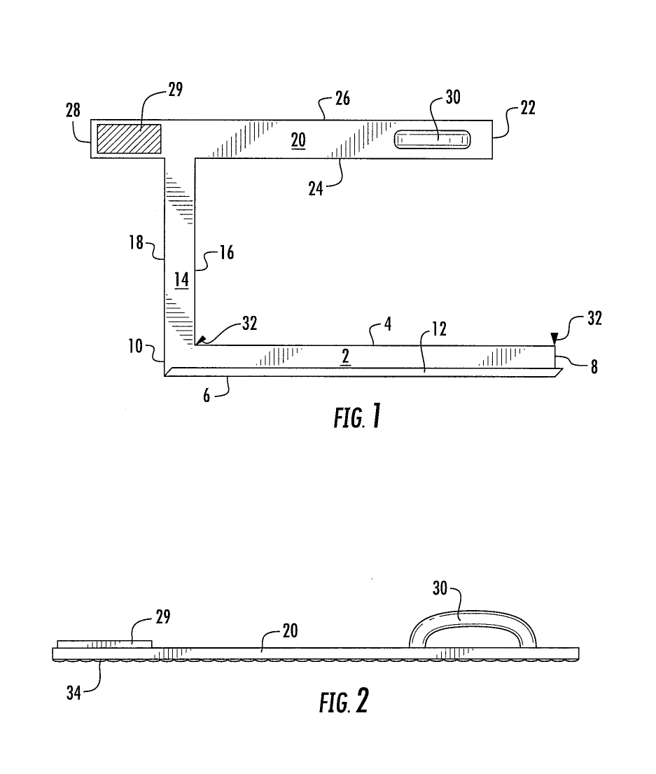

Referring to FIGS. 1 through 3, the cutting guide can include a guide plate 2 that has a generally rectangular shape with a first inner edge 4 running parallel to a first outer edge 6 and a first front edge 8 parallel to a first back edge 10 thereby defining the rectangular shape of the guide plate 2. The guide plate 2 has a generally flat top surface and a flat bottom surface. The guide plate 2 should be manufactured from semi-rigid or rigid material in order to not move when one is using the cutting tool. The guide plate 2 can also be of varying sizes depending on the application of the cutting guide.

Extending perpendicularly from the top surface of the guide plate outer edge 22 is the rail 12. The rail 12 can be an extension of the guide plate 2 or the rail 12 could be a separate piece of material affixed to the guide plate 2. It should be appreciated by those skilled in the art that the only requirement for the rail 12 is that it must provide a rigid surface against which the base plate of a cutting tool can be placed such that the cutting tool can continuously move along guide plate 2 and maintain contact with the length of the rail 12. The width of guide plate 2 from inner edge 4 to the outer edge 6 is manufactured or moveably adjusted such that a cutting tool blade or bit projects downward past inner edge 4 of guide plate 2 while the cutting tool base plate remains in contact with rail 12. The power tool cutting blade or bit extends downward from the power tool lateral to the inner edge 4 of the guide plate 2 and downward beyond the bottom surface of the guide plate 2 and into the substrate to be cut. Thus, the rail 12 must provide a stable surface for the cutting tool to rest against as the cut is made. The rail 12 can be made to varying sizes and specifications depending on the intended application. The height of rail 12 is greater than the thickness of the base plate of the power tool that will be aligned with the cutting guide. Further, it should be apparent that the rail 12 could be manufactured to be removable from the guide plate 2 such that rails 12 of differing sizes or designed specifically for different tools can be attached to the guide plate 2. Although not shown in the Figures, it should be appreciated by those skilled in the art that the guide plate 2 or rail 12 may be modified with specialized grooves, additional rails, or other effective means to engage or interlock with corresponding specialized components of the base plate of a power tool, thereby further facilitating proper alignment during power tool cutting or grinding operations.

Extending from the guide plate inner edge 4 near the first back edge 10 is a connecting plate 14 that has generally a rectangular shape. The connecting plate 14 has a connecting plate interior edge 16 that is parallel to a connecting plate exterior edge 18. The connecting plate 14 extends away from guide plate 2 and connects in a rigid manner to control plate 20. The connecting plate 14 can be manufactured from either the same or a different semi-rigid or rigid material as the guide plate 2. It should be appreciated by those skilled in the art that a principle function of connecting plate 14 is rigid connection between guide plate 2 and control plate 20 and the connecting plate 14 can be of different sizes and shapes, including the form of a tube. Although not shown in the Figures, it is contemplated that the connecting plate could be manufactured to be adjustable, thereby allowing one to shorten or lengthen the distance between the guide plate 2 and the control plate 20. It should also be apparent that connecting plate 14 may alternatively attach to the first inner edge 4 of guide plate 2 at or near the first front edge 8 of guide plate 2 and extend away from guide plate 2 to connect in a rigid manner to control plate 20 at a point nearer to a control plate front edge 22 of control plate 20.

The Figures demonstrate a generally ninety degree angle of connection between guide plate 2 and connecting plate 14. The Figures similarly demonstrate a generally ninety degree angle of connection between connecting plate 14 and control plate 20. Although not shown in the Figures, it should be apparent to those skilled in the art that the cutting guide could be manufactured with connecting plate 14 attaching to either guide plate 2 or control plate 20 at any effective angles of attachment to improve ergonomic structure for a user. It is further contemplated that the connecting plate 14 angle of attachment to either guide plate 2 or control plate 20 could be manufactured to be adjustable.

Extending from the connecting plate 14 on the end opposite from the attachment to guide plate 2 is control plate 20. Control plate 20 can be manufactured from either the same or a different semi-rigid or rigid material as the guide plate 2. Said control plate 20 is generally in the shape of a rectangle with a control plate inner edge 24 running parallel to a control plate outer edge 26 and a control plate front edge 22 parallel to a control plate back edge 28 thereby defining the rectangular shape of the control plate 20. Control plate 20 has a generally flat top surface and a flat bottom surface. Attached to the top surface of control plate 20 is a pressure pad 29 running along the top surface of control plate 20 from the control plate back edge 28 toward the control plate front edge 22 that extends for a distance up the control plate 20. Said pressure pad 29 is a generally flat item with solid but cushioning characteristics whereon a user can rest a knee and exert downward force during cutting or grinding operations on a generally horizontal surface. A handle 30 is attached to the top surface of control plate 20 near the control plate front edge 22 such that a user can hold the cutting guide by the handle 30, or one can use the handle 30 in conjunction with the pressure pad 29 to maintain the cutting guide in fixed position upon a generally horizontal surface to be cut. It should be readily appreciated that the size and shape of the control plate 20, pressure pad 29, and handle 30 can vary according to the intended use of the cutting guide.

As an optional accessory, the saw guide can be provided with an additional feature to aid in using the saw guide on surfaces with indentations such as grout lines. An alignment rod 32 can be permanently or removably affixed to the opposite ends of guide plate 2 lateral to first inner edge 4 through conventional means. Said alignment rods 32 are generally rigid rods of a caliber generally corresponding to the width of an intended cut line created by a power tool in conjunction with the cutting guide. One alignment rods is positioned parallel with first inner edge 4 and extends past first front edge 8. A second alignment rod 32 is positioned parallel with first inner edge 4 and extends past first back edge 10 or out from connecting plate interior edge 16. The distance from the rail 12 to the nearest edge of each alignment rod 32 is equivalent to the distance from the outer margin of a given power cutting tool base plate and the nearest edge of the cutting blade, routing bit, or drill bit. The length of each alignment rod 32 is generally short, with a length sufficient only to adequately aid a user in properly positioning the cutting guide. The alignment rods 32 would be placed into the grout line that corresponds with the desired cut line but a given cut with the power tool would not extend forward or backward sufficiently for the cutting blade, routing bit, or drill bit to make contact with either alignment rod 32.

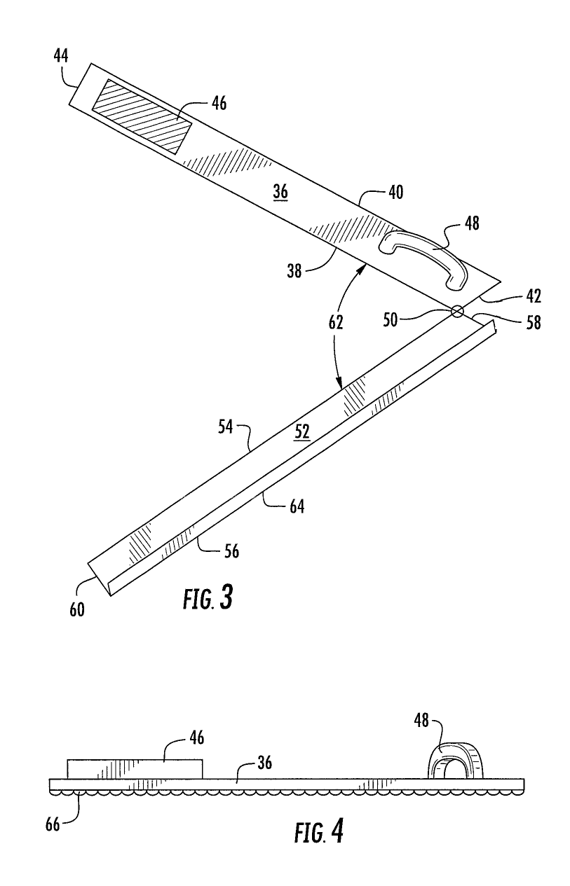

Turning to FIG. 2, the cutting guide is contemplated to optionally include a foot 34 affixed to the underside of the control plate 20. The foot 34 would run a distance under the control plate 20 such that when the cutting guide is placed on a surface, the foot 34 would engage the surface and form a layer between the surface and the control plate 20 of the cutting guide. It is contemplated that the foot 34 would be manufactured from a substance that possessed qualities of surface friction in order to limit the amount of slipping between the control plate 20 and the surface. The foot 34 is directly underneath the pressure pad 29 on the top side of the control plate 20. Thus, the pressure exerted on the pressure pad 29, typically by a user's knee, would transfer directly through the control plate 20 and into the foot 34, thereby holding the cutting guide securely in place on the surface. Likewise, the foot 34 can extend under the control plate 20 directly below the handle 30. It should be appreciated that the foot 34 is not limited to the area of the control plate 20 but could also be utilized under the connecting plate 14 and the guide plate 2.

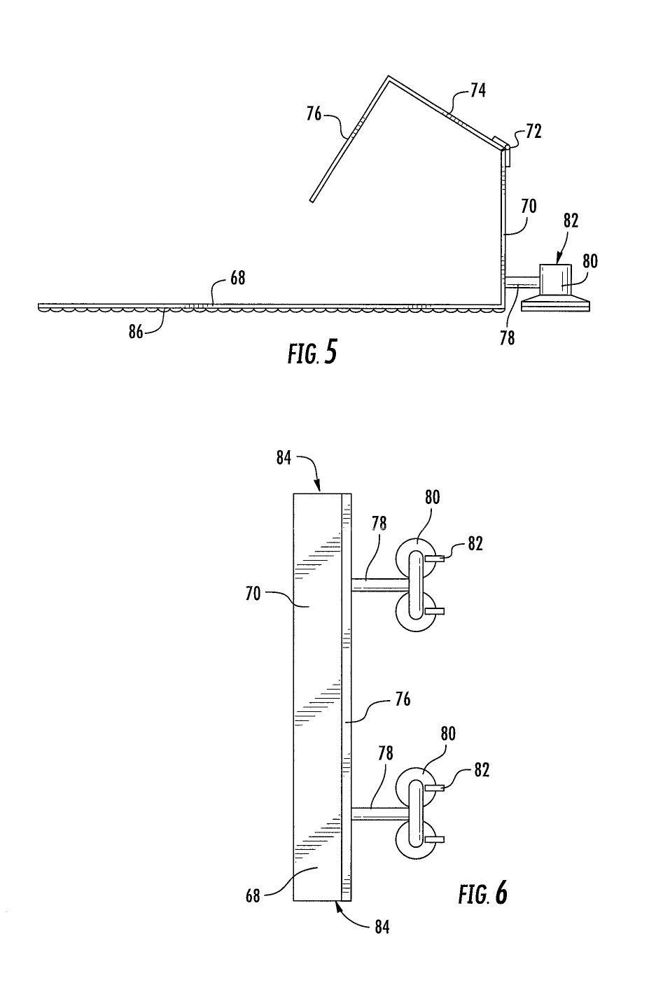

Referring now to FIG. 3 and FIG. 4 which show a first alternative embodiment of the present invention where a control plate 36 is a flat item manufactured from a semi-rigid or rigid material. Said control plate 36 is generally in the shape of a rectangle with an inner edge 38 running parallel to an outer edge 40 and a front edge 42 parallel to a back edge 44 thereby defining the rectangular shape of the control plate 36. Optionally attached to the control plate 36 is a pressure pad 46 running along the control plate 36 from the back edge 44 toward the front edge 42 that extends for a distance up the control plate 36. An optional handle 48 is attached to the control plate 36 near the front edge 42 such that one can hold or carry the cutting guide by the handle 48, or one can use the handle 48 in conjunction with the pressure pad 46 to maintain the cutting guide in fixed position on the surface to be cut. It should be readily appreciated that the size of the control plate 36, pressure pad 46, and handle 48 can vary according to the intended use of the cutting guide.

Affixed to the front edge 42 of the control plate 36 is a pivoting, lockable hinge 50 (hinge). It should be understood by those skilled in the art that the hinge 50 would typically be of the type that is configured in a circular shape with raised teeth that correspond to a second circular disc with raised teeth in opposite relation to the first disk. This second disk is affixed to an alternate item such that when placed together the teeth from the first half engage the teeth from the second half and thereby securely attach at varying angles. It is contemplated that the hinge 50 would be secured by a wing nut or other conventional means.

The hinge 50 is affixed to a guide plate 52 that also has a generally rectangular shape. The guide plate 52 has a guide plate inner edge 54 that faces the inner edge 38 of the control plate 36. The guide plate 52 is also defined by a guide plate outer edge 56 running parallel to the guide plate inner edge 54 and a guide plate front edge 58 running parallel to a guide plate back edge 60, each of which combine to define the generally rectangular shape of the guide plate 52. The guide plate 52 should be manufactured from semi-rigid or rigid material in order to not move when one is using the cutting tool. The guide plate 52 can also be of varying sizes depending on the application of the cutting guide.

The hinge 50 allows the control plate 36 and the guide plate 52 to be configured at different angles such that the inner edge 38 and the guide plate inner edge 54 define an angle 62 defined by the hinge. Thus, the control plate 36 can be placed against a wall and the angle 62 adjusted to align the guide plate 52 with a desired cut line. This is particularly useful when cutting grout lines in flooring adjacent to a wall.

Extending from the guide plate outer edge 56 is a rail 64. The rail 64 can be an extension of the guide plate 52 or the rail 64 could be a separate piece of material affixed to the guide plate 52. It should be appreciated by those skilled in the art that the only requirement for the rail 64 is that it must provide a surface against which a cutting tool can be placed such that the cutting tool can move up and down the rail 64 while cutting. Thus, the rail 64 must provide a stable surface for the cutting tool to rest against as the cut is made. The rail 64 can be made to varying sizes and specifications depending on the intended application. Further, it should be apparent that the rail 64 could be manufactured to be removable from the guide plate 52 such that rails 64 of differing sizes or rails 64 designed specifically for different tools can be attached to the guide plate 52.

FIG. 4 shows an optional foot 66 affixed to the bottom of the control plate 36. The foot 66 could also be used on the bottom of the guide plate 52 to provide additional surface friction to aid in preventing the cutting guide from slipping on the surface.

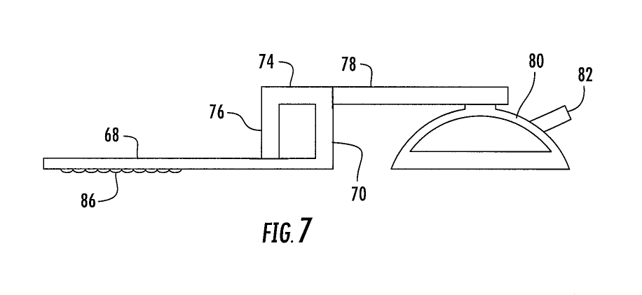

Turning to FIG. 5 and FIG. 6 another embodiment of the present invention is shown. A control plate 68 substantially similar to the control plate 20 shown in FIG. 1 and the control plate 36 shown in FIG. 3 is provided. Affixed along the side of the control plate 68 is a first support 70 that extends essentially perpendicularly from the control plate 68. The first support plate 70 is manufactured from semi-rigid or rigid material such that it is stable and does not bend or deform. A conventional hinge 72 is affixed at the top edge of the first support 70 and is affixed to a second support 74 such that the second support 74 can rotate from the first support 70. Extending from the end of the second support 74 is a rail 76 that is substantially perpendicular to the second support 74. The rail 76 provides a surface against which a cutting tool is placed in order to provide a stable, continuous cutting guide. It should be appreciated by those skilled in the art that the dimensions of the first support 70, the second support 74, and the rail 76 can be altered to varying sizes depending on the desired application of the cutting guide. The second support 74 and the rail 76 are movably attached to the first support 70 by a hinge 72 such that the rail 76 can be rotated into perpendicular alignment with the control plate 68. Thus, the rail 76 provides a stable surface along which a cutting tool can be moved such that a linear cut is made. Although not shown, an optional spacer bar can be affixed to the control plate 68 to accommodate varying sizes of cutting tools, and move the cut a set distance from the first support 70.

In order to secure the cutting guide to the surface and protect against slipping, a beam 78 is affixed to the first support 70 and extends to a suction cup apparatus 80. The suction cup apparatus 80 is a conventional suction cup apparatus 80 with a switch 82 to engage suction. The suction cup apparatus 80 is configured to provide suction against the surface upon which the cutting guide is placed. Although not shown, an alignment rod 32 (as shown in FIG. 1) can be affixed to the ends of the control plate 68 in order to provide guidance on where to align the cutting guide with respect to the desired cut. Additionally, an optional foot 86 can be affixed to the underside of the control plate 68 (best shown in FIG. 5). The foot 86 and the suction cup apparatus 80 would assist in securing the cutting guide to the surface while cutting to minimize the risk of slipping.

Although the present invention has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

I claim:

1. A cutting guide that provides a means to guide a power cutting tool comprising:
A control plate;
A connecting plate affixed to said control plate and extending in a generally perpendicular relation from said control plate;
A guide plate affixed to said connecting plate and extending in a generally perpendicular relation from said connecting plate such that said guide plate is generally parallel to said control plate and said control plate, said connecting plate, and said guide plate are aligned substantially in planar relation to each other;
A rail affixed to said guide plate and extending upwardly from said plane formed by said control plate, said connecting plate, and said guide plate, such that said rail is securely held in vertical relation from said plane by said guide plate.

2. The cutting guide of claim 1, further comprising:
A pressure pad affixed to the top surface of said control plate;
A foot affixed to the underside of said control plate and optionally said connecting plate, and/or said guide plate, said foot providing additional friction between the cutting guide and the surface upon which it is placed;
A handle affixed to the top surface of said control plate.

3. The cutting guide of claim 1 further comprising:
One or more alignment rods affixed to said guide plate such that said alignment rods can be placed on or into the material to be cut, and
Wherein said connecting plate is adjustable in length.

4. A cutting guide comprising:
A control plate;
A lockable hinge affixed to one end of said control plate;
A guide plate affixed to said lockable hinge in opposing relation to said control plate wherein said lockable hinge is adjustable and can be locked into a plurality of positions forming angles between the edges of said control plate and said guide plate, said control plate and said guide plate forming a plane; and
a rail affixed to said guide plate and extending upwardly from said guide plate, such that said rail is securely held in vertical relation from said plane by said guide plate.

5. The cutting guide of claim 4 further comprising:
A pressure pad affixed to the top surface of said control plate;
A foot affixed to the underside of said control plate and optionally said connecting plate and/or said guide plate, said foot providing additional friction between the cutting guide and the surface upon which it is placed; and
A handle affixed to the top surface of said control plate.

6. A cutting guide for a power cutting tool comprising:
A control plate;
A support affixed to and extending vertically along the length of said control plate;
A plurality of hinges disposed along the top surface of said support;
A second support affixed to said plurality of hinges such that said second support can rotate about an axis defined by said plurality of hinges, said second support forming adjustable angles with said support;
A rail affixed to said second support and extending the length of said second support such that said rail rotates with said second support and can rotate to an angle such that said rail contacts said control plate and provides a surface against which a power cutting tool can be placed.

7. The cutting guide of claim 6 further comprising:
A beam affixed to said support and extending away from said control plate; and
A suction cup apparatus attached to said beam and oriented downwardly in order to engage a surface upon which the cutting guide is placed and create suction thereby securing said control plate to said surface.

8. The cutting guide of claim 6 further comprising:
A pressure pad affixed to the top surface of said control plate;
A foot affixed to the underside of said control plate, said foot providing additional friction between the cutting guide and the surface upon which it is placed;
A handle affixed to the top surface of said control plate; and
A spacer bar affixed to the control plate.
